(19) United States
(12) Patent Application Publication
(10) Pub. No.: US 2022/0085562 A1
(43) Pub. Date: Mar. 17, 2022

(54) METHOD AND DEVICE FOR CHECKING THE QUALITY OF A CRIMPING

(71) Applicant: HARTING ELECTRIC GMBH & CO. KG, Espelkamp (DE)

(72) Inventors: Till RIECHMANN, Stemwede (DE); Felix LOSKE, Minden (DE); Maren KNOP, Enger (DE)

(21) Appl. No.: 17/423,848

(22) PCT Filed: Jan. 10, 2020
(86) PCT No.: PCT/DE2020/100017

§ 371 Date: Jul. 16, 2021

(30) Foreign Application Priority Data
Jan. 16, 2019 (DE) 10 2019 101 016.0

(51) Int. Cl. H01R 43/048; G01D 5/14; G01L 1/16; B21D 39/04

(52) U.S. Cl. CPC H01R 43/0486; G01D 5/145; H01R 43/0488; B21D 39/048; G01L 1/16

(57) ABSTRACT

Disclosed is a method and a device for checking the quality of a crimping of a specified cable with a specified contact sleeve using a sensor system for measuring a force and a displacement of a device for the actuation and/or force application of a crimping unit and using an electronic analysis system. In the method a force/displacement curve is detected during the crimping process and is displayed on a screen, wherein the method has the following steps: a stored reference model is displayed on the screen together with the detected force/displacement curve, said reference model having a first and a second envelope curve which define a tolerance range;—comparing the force/displacement curve with the reference model, thereby ascertaining whether the force/displacement curve lies in the tolerance range; and—arriving at a conclusion regarding the quality of the crimping from the comparison.

The invention relates to a method for checking the quality of a crimp and a suitable device for performing the method.

In crimping, two components are connected to one another by plastic deformation under a pressure force by means of a forming tool. In this case, a crimp, i.e. a mechanical connection between a conductor and a connecting element, for example a plug or a sleeve, is achieved, which is difficult to separate.

When producing the crimp, a high quality of the crimp is desirable for a permanent mechanically and electrically stable connection between the crimped components. A poor quality crimp can be caused in particular by a faulty crimp blank and also by operating faults at a crimping device, for example an incorrectly set crimp height.

Quality assurance of a crimp connection usually takes place by measuring the crimp depth, via optical appraisal of a microsection and/or by force/displacement monitoring during crimping.

### PRIOR ART

WO 2012/110310 A1 proposes an above-mentioned force/displacement monitoring during crimping. In this case, a crimp blank is plastically deformed by a forming tool. In particular, when the forming tool is retracted, both the force which the forming tool exerts on the crimp blank and the distance by which the forming tool is displaced are measured. A deviation between a position at maximum force and a position which is free of force for the first time is used as an indicator of an elastic spring-back of the crimp blank. This indicator is proposed as a measure of the quality of the produced crimp.

However, reliable use of this indicator for quality assurance requires very accurate measurement of the deviation, which is why the displacement measurement takes place via disadvantageously complex and expensive laser distance measurement.

The German Patent and Trademark office has searched the following prior art in the priority application relating to the present application: EP 0 873 582 Bl, Grundlagen der Crimptechnik-Qualitatskontrolle [Fundamentals of Crimping Technology-Quality Control]; DE 10 2007 063 669 A1; DE 40 38 658 C2 and DE 43 37 796 A1.

Object The object of the invention consists in providing a reliable and cost-effective method for checking the quality of a crimp and a suitable device for performing the method. In this case, a particular object of the invention is to specify a method for checking the quality of an indent crimp of, in particular, a turned contact sleeve and a cable and in particular a four-mandrel crimp.

The object is achieved by the features of the claims.

The present invention relates in particular to a method V for checking the quality of a crimp of a predefined cable with a predefined contact sleeve and with a predefined crimp height using a sensor system for measuring a force and a displacement of an apparatus for the actuation and/or pressure application of a crimping unit and an electronic evaluation system, wherein a force/displacement curve is detected during crimping and displayed on a screen.

The detected force/displacement curve is moreover compared to a stored reference model of at least one reference measurement, wherein the reference model has a first and second envelope, which delimit a tolerance range. In this case, the reference model can be displayed on the screen together with the force/displacement curve. The reference model was suitably created by means of an inventive method VM described below.

A comparison of the force/displacement curve with the reference model is performed, wherein it is determined whether the force/displacement curve is in the tolerance range, and a statement relating to the quality of the crimp is generated. The comparison can take place in an automated manner and/or it can also be performed by an operator if it is obvious that the force/displacement curve deviates from a force/displacement curve of a crimp with a desirable quality.

In this case, the quality of the crimp corresponds to a predefined desirable quality if the force/displacement curve is in the tolerance range, and the quality of the crimp is rejected if the force/displacement curve is at least partially outside the tolerance range.

Via an advantageous joint presentation of the measured force/displacement path of the crimp together with the reference model, an operator is also always able to monitor a comparison which takes place in an automated manner.

In this case, a qualitative fault analysis of the crimp can, in particular, also be particularly advantageously derived from an automated comparison of the force/displacement curve with the reference model. It is thus possible to identify, and promptly and cost-effectively eliminate, causes of faults, for example operating faults, material flaws and, in particular, also a technical failure of the crimping device used. In this case, the qualitative fault analysis can be performed using stored information relating to the assessment of force/displacement curves of faulty crimps.

In an automated comparison, a qualitative analysis with determination of a fault probability can be advantageously performed using the force/displacement curve. For example, a qualitative and, in particular, automated analysis can lead to the conclusion that too large a crimp blank with too large a contact sleeve was used or that, when stripping a cable or when inserting a cable into a contact sleeve, the strand of the cable was impaired. The conclusion of the analysis can be suitably and advantageously displayed on the screen together with the force/displacement curve.

In addition to the above method V, the invention furthermore relates in particular to a method VM for creating a reference model for checking the quality of a crimp of a predefined cable with a predefined contact sleeve and with a predefined crimp height using a sensor system for measuring a force and a displacement of an apparatus for the actuation and/or pressure application of a crimping unit and an electronic evaluation system, wherein a force/displacement curve is detected during crimping and displayed on a screen.

In this case, the method VM is particularly suitable for creating a reference model for the above-described method V of the invention.

In the method VM, crimping of a cable with a contact sleeve is performed in a first step and a force/displacement curve of the crimp is detected and displayed on the screen. In a second step, the quality of the crimp is assessed via visual inspection by an operator and/or with the use of suitable testing instruments. For example, the assessment can be performed optically, in particular by examining a microsection of a cross-section through the crimp or by resistance measurement.

For a positively assessed crimp with a predefined quality, the force/displacement curve for a family of curves with a predefined number n of force/displacement curves is provided in a third step of the method VM. As a result of this measure, it is advantageously possible to take into account mutually deviating force/displacement measurements due to measuring tolerances, for example. In this case, the provision of a family of curves is particularly suitable for determining a tolerance range described below.

The above first, second and third step of the method VM is repeated with a further cable and a further contact sleeve in a fourth step, until the predefined number n of force/displacement curves is reached.

Series of tests have shown that a predefined number of n=3 already gives satisfactory results for crimps using the above-described method V, in particular when comparisons are also performed in an automated manner. A predefined number of n>=5, and particularly preferably n=10, is preferably suitable for determining a desirably accurate tolerance range involving reasonable effort for the creation the reference model.

An above-mentioned tolerance range can be particularly advantageously provided in a fifth step, taking into account the predefined number n of the force/displacement curves. A first and second envelope, which delimit the family of the force/displacement curves and moreover define the tolerance range, can be determined in a simple manner.

In this case, the tolerance range can be advantageously variably specified according to the displacement and/or the force, whereby a particularly accurate appraisal of a crimp and the force/displacement curve characterizing it is possible.

When specifying the tolerance range, a predefined tolerance and/or a predefined quality and/or the predefined cable and/or the predefined contact sleeve and/or a predefined crimp height and/or the predefined number n can furthermore be suitably taken into account. The opportunity is thus created to particularly precisely define and moreover optimize and individually adapt a tolerance range.

In a sixth step, the first and second envelope and/or the tolerance range and/or the family of force/displacement curves with the number n can be recorded or stored as a reference model for performing a crimp for use in the above-described method V.

In the above sixth step, further data characterizing the reference model and/or a crimp can be stored together with the reference model, wherein the data can comprise a time stamp and/or a location and/or ID information relating to the crimping device used and/or ID information relating to the operator and/or the predefined number n and/or the predefined cable and the predefined contact sleeve and/or information relating to the assessment of force/displacement curves of faulty crimps.

A performance of the method VM at least from step one to step four can furthermore be added to a number N of performances of the method VM which have already taken place, and/or, in step five, the tolerance range can also be defined taking into account the number N, and/or the above further stored data characterizing the reference model and/or a crimp can comprise the number N. With the number N, a further parameter for classifying the reference model is, in particular, also advantageously provided in addition to the number n.

It is advantageous to use the above-described method V for updating and desirable individual fine-tuning and/or optimization of the reference model. A force/displacement curve of a predefined quality can be used for updating the reference model and step five and/or six of the method VM can be performed, wherein the performance of a crimping process can be added to the predefined number n and/or the number N. In this case, the update can be performed in an automated manner and/or at the instigation of an operator. An advantageously dynamic reference model and/or dynamic envelopes and/or a dynamic tolerance range are thus provided.

The above methods V and VM are suitably provided by means of a software program, which can be provided on the electronic evaluation system. The method V and VM can be particularly advantageously provided by means of just one software program, wherein the methods V and VM share a plurality of routines of the software program. In this case, an operating mode of the software program which is suitable for the method V and/or VM in each case can be selected by an operator.

In this way, a particularly simple and advantageous use of the reference model is possible and the opportunity is also created to adapt and optimize the reference model dynamically in an individually suitable manner.

In the methods V and VM, a position transmitter, which is equipped with a Hall sensor, is particularly advantageously used for the displacement measurement and at least one piezoelectric sensor is suitably used for the force measurement. In this case, the sensors are moreover advantageously designed and arranged for desirable measuring accuracy in such a way that they measure a displacement and a force of the apparatus for the actuation and/or pressure application on the crimping unit.

For desirable measuring accuracy, Hall sensors and piezoelectric sensors can be acquired relatively cost-effectively.

The invention moreover relates in particular to a crimping device for checking the quality of a crimp of a predefined cable with a predefined contact sleeve and with a predefined crimp height using a sensor system for measuring a force and a displacement of an apparatus for the actuation of a crimping unit and an electronic evaluation system, wherein a force/displacement curve is detected during crimping and displayed on a screen.

A crimping unit which is particularly suitable for press-connecting the cable to a contact sleeve, in particular a turned contact sleeve, can advantageously be an indent crimping unit, for example a two-mandrel crimping unit, and particularly preferably a four-mandrel crimping unit.

As an apparatus for the actuation of the crimping unit, the crimping device suitably has a pneumatic pressure apparatus with a cylinder and a piston which are in operative communication with the crimping unit via a lever. An above position transmitter can be easily provided on the cylinder for the displacement measurement and at least one above piezoelectric sensor can be provided on at least one attachment of the cylinder and/or on the lever for the force measurement.

An adjustment mechanism is provided for setting a predefined crimp height, whereby the crimping device is suitable for different applications. The crimping device can moreover have a cable stripping apparatus, which can be provided on the crimping unit.

The crimping device is therefore suitably designed for performing an above-described method V and VM.

As stated above, the methods V and VM can be provided by means of a software program, which can be provided on the electronic evaluation system of the crimping device.

In this case, the electronic evaluation system can be designed in particular for evaluating the force and displacement measurement for an in particular also automated comparison of a force/displacement curve with a reference model and/or for a qualitative fault analysis, in particular also with data relating to the probability thereof, and for controlling the screen. The electronic evaluation system can moreover have interfaces for wired and/or wireless signal and/or data links. The crimping device can thus be connected to a network, whereby a predefined fault message for a crimp of a method V and VM can be sent to an external device. For example, such an above fault message can take place on a mobile phone, thereby providing the opportunity for advantageously prompt maintenance of a crimping unit.

For easy operation, the screen can suitably be a touch-screen.

An above-described reference model created via a method VM can moreover be suitably used for monitoring the quality of a crimp by means of a method V using a first above crimping device, wherein the reference model was created using a second crimping device.

In this case, the reference model can, in particular, also be advantageously dynamically adapted and/or optimized to the characteristics of the first crimping device via an above-described updating of the reference model using the method V and/or the method VM. In this way, by means of the methods V and VM, the opportunity is created to design a crimping device such that it is optimized in a particularly efficient and cost-effective manner. Moreover, an apparatus of a crimping device can thus be optimized in a substantially automated manner during operation of the crimping device.

Advantageous embodiments of the invention are indicated in the subclaims and/or in the description below.

### EXEMPLARY EMBODIMENTS

Exemplary embodiments of the invention are illustrated in the drawings and will be explained in more detail below. In the drawings:

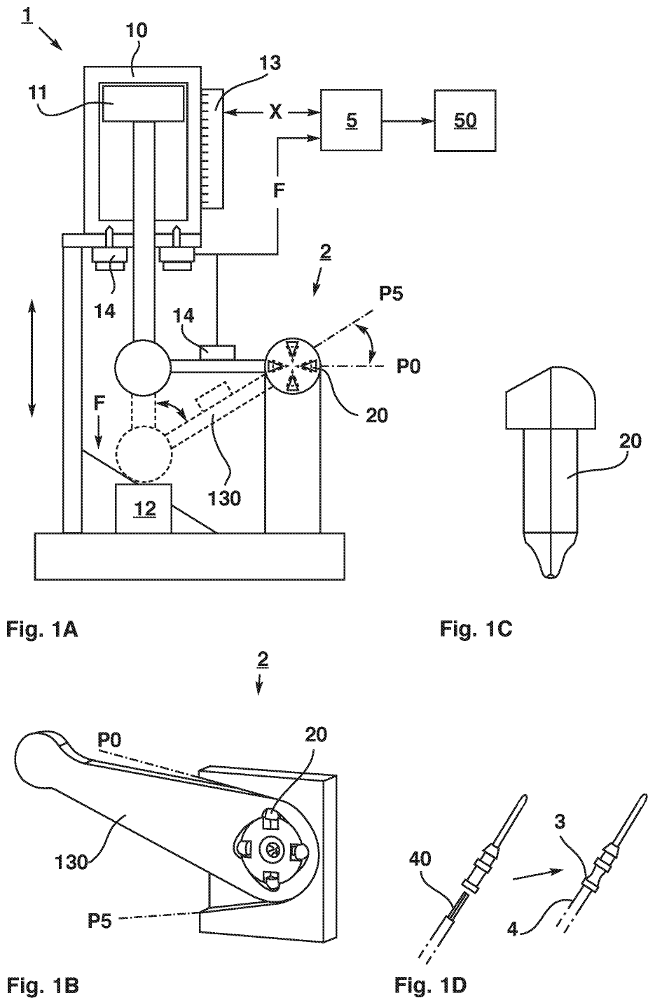

FIG. 1A shows a schematic illustration of a crimping device with a crimping unit according to an embodiment of the invention;

FIG. 1B shows an enlarged detailed illustration of the crimping unit of FIG. 1A;

FIG. 1C shows an enlarged mandrel of the crimping unit of FIGS. 1A and 1B,

FIG. 1D shows a cable with a contact sleeve, separately and crimped to one another;

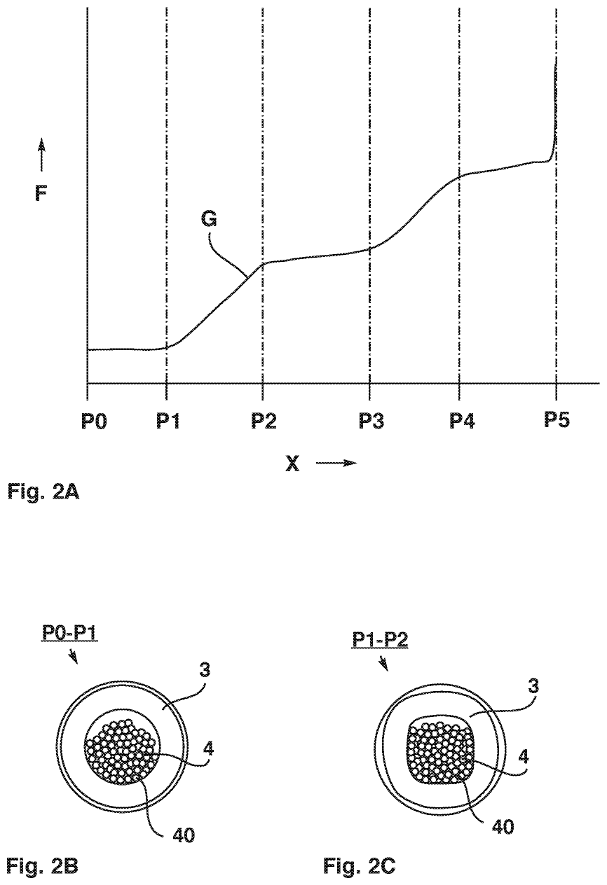

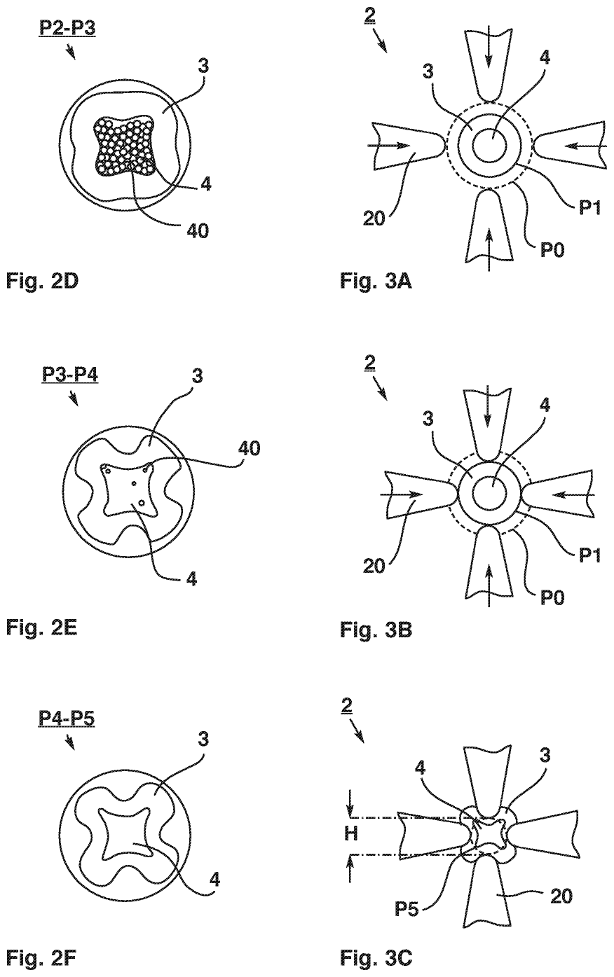

FIG. 2A shows a force/displacement curve of a crimp according to an embodiment of the invention;

FIG. 2B shows a cross-section through a contact sleeve provided as intended for crimping with a cable;

FIG. 2C-FIG. 2F each show microsections of a cross-section through a crimp of the contact sleeve with the cable of FIG. 2B in various stages of crimping;

FIG. 3A shows a further enlarged illustration of the crimping unit of FIG. 1A in a rest position, together with a contact sleeve arranged as intended for crimping and a cable;

FIG. 3B the crimping unit of FIG. 3A in a first position;

FIG. 3C the crimping unit of FIGS. 3A and 3B in a further position;

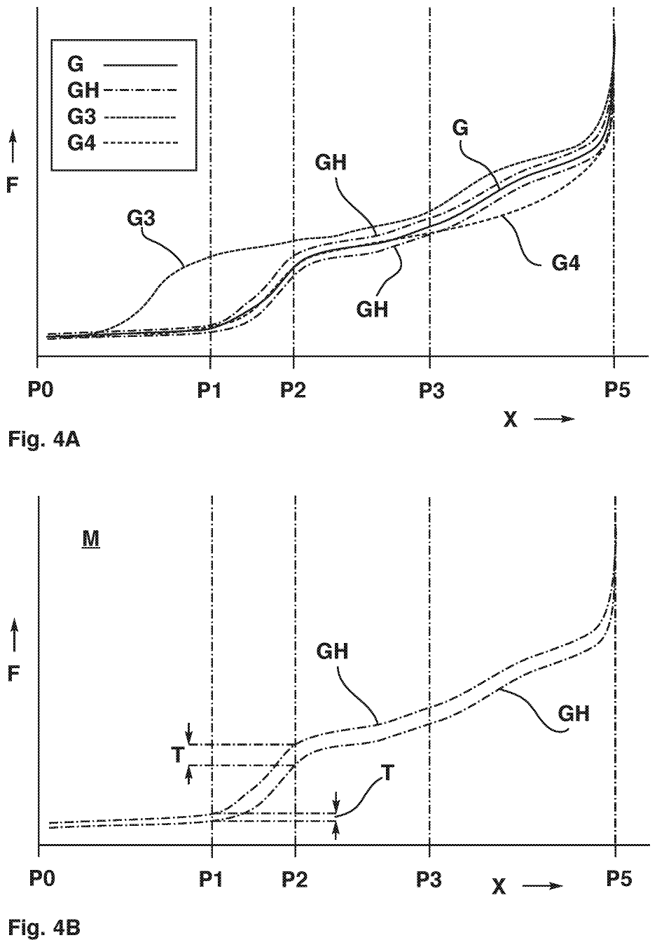

FIG. 4A further force/displacement curves of a crimp together with two envelopes of a reference model according to an embodiment of the invention;

FIG. 4B a reference model for checking the quality of a crimp according to an embodiment of the invention; and

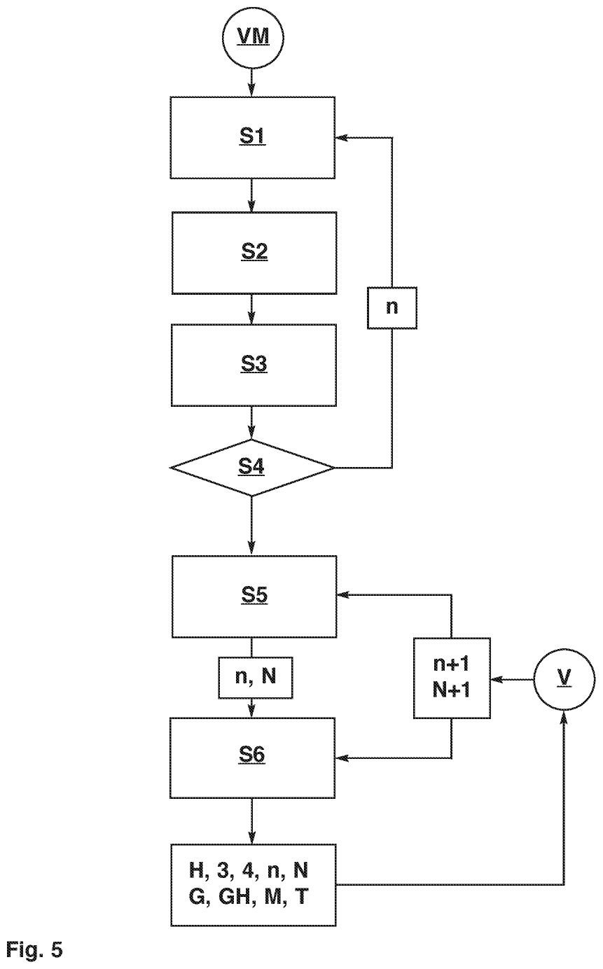

FIG. 5 a schematic flow chart of a method for creating a reference model of FIG. 4B.

The figures contain partially simplified, schematic illustrations. Identical reference signs are sometimes used for elements which are similar but possibly not identical. Different views of similar elements may be drawn to different scales. For the sake of simplicity and clarity, only one similar or similar type of element is denoted by a reference sign in the drawings in each case.

FIG. 1A shows a schematic illustration of a crimping device 1 according to an embodiment of the invention, and FIG. 1D shows a cable 4 with a contact sleeve 3, mutually separate and crimped to one another. The contact sleeve 3 is a turned contact sleeve 3.

The crimping device 1 is an indent crimping device and in particular a four-mandrel crimping device with a crimping unit 2 having four mandrels 20, which is particularly suitable for press-connecting a strand of a stripped single-core cable 4 to a turned contact sleeve 3.

For the actuation of the crimping unit 2, the crimping device 1 has a pneumatic pressure apparatus with a cylinder 10 and a piston 11, which is in operative communication with the crimping unit 2 via a lever 130. A suitable adjustment mechanism 12 is provided for setting a predefined crimp height.

For a crimp by means of a press-connection of a contact sleeve 3, in particular a turned contact sleeve 3, and a cable 4, the contact sleeve 3, with the strand of the cable 4 located therein, is inserted as intended into the crimping unit 2, and the crimping unit 2 is actuated by means of the pressure apparatus and subjected to pressure. The lever 130 coupled to the crimping unit 2 is pivoted via a vertical movement and a vertically acting force F of the pressure apparatus. In this case, the crimping unit 2 and the lever 130 are designed and arranged in such a way that the mandrels 20 move towards one another from their rest position P0 or are brought into their rest position P0 during a pivotal movement, which will be described below with reference to FIG. 1B. In this case, the tips of the mandrels 20 are each located on concentric circles, which will be described below with reference to FIGS. 3A, 3B and 3C.

The crimping device 1 is suitably designed for checking the quality of a crimp of a predefined cable 4 with a predefined contact sleeve 3 and, to this end, has a displacement sensor 13 and at least one force sensor 14. The displacement sensor 13 can suitably be a position transmitter with a Hall sensor and can be provided on the cylinder 10 of the pressure apparatus. The force sensor 14 can suitably be a piezoelectric sensor 14 and can be arranged on the lever 130 and/or at it can be at least one piezoelectric sensor provided on an attachment of the cylinder 10. In this case, the piezoelectric sensors each measure a stress or strain during the actuation of the lever 130 or the counter-force of a pressure acting on the piston 11, which counter force acts on the cylinder 10.

The sensor system 13, 14 is connected to an electronic evaluation system 5 via a signal and/or data link. The electronic evaluation system 5 controls a screen 50 and displays a force/displacement curve G of a crimp, which is detected using the signals of the sensor system 13, 14, together with further information on the screen 50. An example of a force/displacement curve G is described below with reference to FIG. 2A.

FIG. 1B shows an enlarged, detailed illustration of the crimping unit 2 and FIG. 10 shows an enlarged mandrel 20 of the crimping unit of FIGS. 1A and 1B. For the sake of clarity, the force sensor 14 on the lever 130 is not illustrated in FIG. 1B.

The crimping unit 2 has a cylindrical guide, in which four mandrels 20 are mounted to be radially movable. The tips of the mandrels 10 are aligned towards one another. The lever 130 is mounted on the cylindrical guide to be axially pivotable or rotatable and has an inner contour which cooperates with heads of the mandrels 20, which project out of the cylindrical guide. During a pivotal movement of the lever 130, the tips of the mandrels 20 are moved towards one another or away from one another in the direction of the axis of the cylindrical guide or the pivot axis of the lever 130. During crimping, a contact sleeve 3 provided with a cable 4 is thus press-connected to the cable 4 via the actuation of the lever 130 on the axis of the cylindrical guide.

The crimping unit 2 with its mandrels 20 is moreover described below with reference to FIGS. 3A, 3B and 3C.

A crimping device 1 with the above-described features is suitable for performing a method V and VM described at the outset and below, also with particular reference to FIG. 5.

FIG. 2A shows a force/displacement curve G of a crimp of a contact sleeve 3 with a cable 4 of FIG. 1D according to an embodiment of the invention, the crimp being performed by means of a crimping device 1 of FIG. 1A.

During crimping, the mandrels 20 of the crimping unit 2 are brought from their rest position P0 into further positions P1 to P5, wherein the tips of the mandrels 20 are each arranged on concentric circles. In this case, a displacement X and a force F are measured by the sensor system 13, 14 and are illustrated by the force/displacement curve G. Positions P1 to P5 of the mandrels 20 correlate to the positions P1 to P5 in each case and thereby each correspond to a measured displacement X of the sensor 13.

An enlarged illustration of the crimping unit 2 of FIG. 1A in the rest position P0, together with a contact sleeve 3 arranged as intended for crimping in the crimping unit 2 and a cable 4, is illustrated in FIG. 3A. In this case, the tips of the mandrels 20 of the crimping unit 2 are arranged concentrically with the contact sleeve 3.

In this case, a displacement of the mandrels 20 from the position P0 to the position P1 takes place under a constant force F. Accordingly, the progression of the force/displacement curve G is also constant in a first region P0-P1 between the position P0 and the position P1 of the mandrels 20. In the position P1, the mandrels 20 of the crimping unit 2 touch the surface of the contact sleeve 3. This position P1 of the mandrels 20 is illustrated schematically in FIG. 3B.

In comparison to FIG. 3A, FIG. 2B shows an enlarged and more detailed illustration of a cross-section through a contact sleeve 3 provided as intended for crimping with a cable 4. In addition to individual wires 40 of the strand of the cable 4, the interior of the contact sleeve 30 has a void which is not occupied by the individual wires 40 of the strand. The contact sleeve 3 is intact and its state corresponds to that of the contact sleeve 3 of FIGS. 3A and 3B in the region P0-P1 of the crimp with the force/displacement curve G.

In the further progression of the force/displacement curve G, the force F increases approximately linearly from the position P1 to a position P2 of the mandrels 20, wherein an elastic deformation of the contact sleeve 3 takes place in this region P1-P2. In this case, the individual wires 40 of the strand of the cable 4 are arranged in the contact sleeve 3 together with a comparatively smaller void, which is illustrated in a microsection of the contact sleeve 3 for the region P1-P2 of FIG. 2C.

Subsequently, a comparatively flat progression of the force/displacement curve G takes place from the position P2 to a position P3 of the mandrels 20, wherein a first irreversible deformation of the contact sleeve 3 takes place in the region P2-P3. The space available for the strand in the contact sleeve 3 is restricted considerably in this region P2-P3 so that a comparatively small void is present in addition to the individual wires 40 of the strand. This state of the contact sleeve 3 and the strand is illustrated in a microsection of the contact sleeve for the region P2-P3 of FIG. 2D.

In its further progression, the force/displacement curve G assumes a steeper progression again from the position P3 to a position P4 of the mandrels 20, wherein, in addition to an elastic deformation of the strand, a further irreversible deformation of the contact sleeve 3 takes place in the region P3-P4 and the strand occupies almost all of the available space in the contact sleeve 3. This state of the contact sleeve 3 and the strand is illustrated in a microsection of the contact sleeve 3 for the region P3-P4 of FIG. 2E, in which only a few individual wires 40 of the strand are discernable and a void is barely present.

Subsequently, a comparatively flat progression of the force/displacement curve G again takes place from the position P4 to a position P5 of the mandrels 20, wherein, in addition to a further irreversible deformation of the contact sleeve 3, a non-elastic deformation of the strand also takes place in the region P4-P5. In this region P4-P5, the strand fills the available space in the contact sleeve 3 completely. This state of the contact sleeve 3 and the strand is illustrated in a microsection of the contact sleeve 3 for the region P4-P5 of FIG. 2F, in which individual wires 40 of the strand are not discernible and a void is not present in addition to the strand.

In this case, FIG. 2F shows a microsection of a crimp with a desirable predefined quality, in which there are no discernable individual wires 40 or splits in the contact sleeve 3 due, for example, to undesired material flaws.

To this end, FIG. 3C shows the mandrels 20 of the crimping unit 2 in the position P5 of the mandrels 20 which corresponds to the position P5 of the force/displacement curve G, wherein the tips of the mandrels 20 are arranged on a circle with a diameter H, which corresponds to the set crimp height H.

The force F of the force/displacement curve G of FIG. 2A increases suddenly in this position P5 and reaches its maximum and then decreases when a strain sensor is used. An above force/displacement curve G is suitable for joint display with a reference model M (described below with reference to FIGS. 4A and 4B) in the inventive method V described at the outset and for checking whether the force/displacement curve G is within a tolerance range T of the reference model M, which is delimited by two envelopes GH.

FIG. 4A shows further force/displacement curves G, G3 and G4 of a crimp together with two envelopes GH of a reference model M according to an embodiment of the invention, and FIG. 4B shows the reference model M for checking the quality of a crimp of FIG. 4A without the force/displacement curves G, G3 and G4.

The two envelopes GH are each illustrated by dot and dash lines in FIG. 4A and delimit a tolerance range T of a family of reference curves G having a predefined distribution. In this case, the tolerance range T varies over the progression of the envelopes GH and, by way of example and in the position P1 in which the mandrels 20 of a crimping unit 2 are just touching a contact sleeve 3, is narrower than in the position P2 in which an irreversible deformation of the contact sleeve 3 occurs.

The force/displacement curve G of FIG. 4A is illustrated by a continuous line and is located between the envelopes GH over its entire progression from the position P0 to the position P5 of the mandrels 20, and corresponds to a crimp of a contact sleeve 3 with a cable 4 with a predefined desirable quality.

The force/displacement curve G3 of FIG. 4A is illustrated by a dashed line and proceeds virtually completely above the two envelopes GH. The force/displacement curve G3 corresponds to a crimp of too large a contact sleeve 3, which is touched and elastically deformed by the mandrels 20 of a crimping unit 2 well before the position P1 provided for touching the contact sleeve 3. Consequently, the force progression F of the force/displacement curve G3 up to the position P2 is well above the tolerance range T.

For a crimp with a force/displacement curve G3, in addition to the curves G3 and GH, the information that the crimp has an undesired quality owing to an incorrectly large contact sleeve 3 can also be displayed on a screen 50 of a crimping device 1. Moreover, the probability of an above-mentioned fault being present can be calculated from the progression of the force/displacement curve G3 by means of an inventive method V described at the outset and likewise displayed on the screen 50.

The force/displacement curve G4 of FIG. 4A is likewise illustrated by a dashed line and initially proceeds within the tolerance range T specified by the two envelopes GH. Unlike the force/displacement curve G3, the force/displacement curve G4 corresponds to a crimp of a correct contact sleeve 3 and too small a cable 4 with too small a strand and/or with too few individual wires 40. Owing to the too small a strand or the too few individual wires 40, the force progression F from approximately the position P3 of the mandrels 20 which is described below with reference to FIG. 2A is below a correct force progression F and outside the tolerance range T specified by the two envelopes GH.

For a crimp with a force/displacement curve G4, in addition to the curves G4 and GH, the information that the crimp has an undesired quality owing to an incorrectly small cable 4 whereof the strand has too few individual wires 40 can be displayed on a screen 50 of a crimping device 1. Moreover, the probability of an above-mentioned fault being present can be calculated from the progression of the force/displacement curve G4 by means of a method V described at the outset and likewise displayed on the screen 50.

As stated above with reference to FIG. 2A, a reference model M of FIG. 4B is suitable for use in the method V described at the outset for joint presentation and/or for automated comparison with a force/displacement curve of a crimp to be checked.

FIG. 5 shows a schematic flow chart of a method VM for creating a reference model M of FIG. 4B of a crimp of a predefined cable 4 with a predefined contact sleeve 3 and with a predefined crimp height H using a crimping device 1 of FIG. 1A with the above-described sensor system 13, 14 and the electronic evaluation system 5, wherein a force/displacement curve G, G3, G4 is detected during crimping and displayed on a screen 50. The method VM has, in particular, the following steps S1 to S6.

In a first step S1, crimping is performed and a force/displacement curve G, G3, G4 of the crimp is detected and displayed on the screen 50.

In a second step S2, an assessment of the quality of the crimp is performed via visual inspection by an operator and/or with the use of suitable testing instruments. For example, the assessment can be performed optically, in particular by examining a microsection according to FIG. 2F, for example, of a cross-section through the crimp.

In a third step S3, a force/displacement curve G of a positively assessed crimp with a predefined quality is used for a family of force/displacement curves G with a predefined number n of force/displacement curves G.

In a fourth step S4, the above first, second and third step is repeated with a further cable 4 and with a further contact sleeve 3, until the predefined number n is reached.

In a fifth step S5, a tolerance range T with a predefined tolerance and/or taking into account the predefined quality and/or the predefined cable 4 and/or the predefined contact sleeve 3 and/or a predefined crimp height H and/or the predefined number n is defined by specifying a first and second envelope GH which delimit the family of force/displacement curves G.

In a sixth step S6, the first and second envelope GH and/or the tolerance range T and/or the family of n force/displacement curves G is recorded as a reference model M according to FIG. 4B for use in the inventive method V described at the outset.

In the sixth step S6, further data characterizing the reference model M and/or a crimp can be stored together with the reference model M, wherein the data can comprise a time stamp and/or a location and/or ID information relating to the crimping device used and/or ID information relating to the operator and/or the predefined number n and/or the predefined cable 4 and/or the predefined contact sleeve 3 and/or the predefined crimp height H and/or information relating to the assessment of force/displacement curves G3, G4 of faulty crimps.

A performance of the method VM at least from step S1 to step S4 can furthermore be added to a number N of performances of the method VM which have already taken place. In step 5, the tolerance range T can moreover be defined, in particular taking into account the number N and/or the further recorded data characterizing the reference model M and/or a crimp.

The method VM described above with reference to FIG. 5 can be provided by means of a software program which can be provided on the electronic evaluation system and which is designed in such a way that it can also be used for the method V described at the outset. In this case, the method V and VM can share a plurality of routines of the software program. In this case, an operating mode of the software program which is suitable for the method V and/or VM in each case can be suitably selected by an operator.

A method V described at the outset can be particularly advantageously used for updating and desirable individual fine-tuning and/or optimization of a reference model M. In this case, a force/displacement curve G of a crimp with a desirable predefined quality can be used for updating the reference model M and step S5 and/or S6 of the method VM can be performed, and/or the performance of a crimping process by means of the method V can be added to the predefined number n and/or the number N. In this case, the update can be performed in an automated manner and/or at the instigation of an operator, wherein, for example, an operating mode of a software program which is suitable for the method V can be switched to an operating mode suitable for the method VM. An advantageously dynamic reference model M and/or dynamic envelopes GH can thus be provided.

Even where combinations of different aspects or features of the invention are shown in the figures in each case, it is clear to a person skilled in the art—unless indicated otherwise—that the combinations shown and discussed are not the only possible combinations. In particular, mutually corresponding units or feature complexes from different exemplary embodiments can be interchanged with one another.

Method and device for checking the quality of a crimping

### LIST OF REFERENCE SIGNS

1 Crimping device
10 Cylinder
11 Piston
12 Adjustment mechanism
13 Displacement sensor
130 Lever
14 Force sensor
2 Crimping unit
20 Mandrel
3 Contact sleeve
4 Cable
40 Individual wire
5 Electronic evaluation system
50 Screen
F Force
X Displacement
H Crimp height
T Tolerance range
V, VM Method
M Reference model
N, n Number
G, GH, G3, G4 Curve
P0, P1, P2, P3, P4, P5, P6 Position
S1, S2, S3, S4, S5, S6 Step

1. A method for creating a reference model for checking the quality of a crimp of a predefined cable with a predefined contact sleeve and with a predefined crimp height using a sensor system for measuring a force and a displacement of an apparatus for the actuation and/or pressure application of a crimping unit and an electronic evaluation system, wherein a force/displacement curve is detected during crimping and displayed on a screen, comprising the steps of:
performing a crimp of a cable with a contact sleeve and detecting and displaying a force/displacement curve of the crimp on the screen in a first step;
assessing the quality of the crimp via visual inspection by an operator and/or with the use of suitable testing instruments in a second step;
using a force/displacement curve of a positively assessed crimp with a predefined quality for a family of force/displacement curves with a predefined number of force/displacement curves in a third step;
repeating the first, second and third steps with a further cable with a further contact sleeve, until a predefined number is reached, in a fourth step;
defining a tolerance range with a predefined tolerance and/or taking into account the predefined quality and/or the predefined crimp height and/or the predefined cable and/or the predefined contact sleeve and/or the predefined number by specifying a first and second envelope, which delimit the family of the force/displacement curves, in a fifth step;
recording the first and second envelope and/or the tolerance range and/or the family of force/displacement curves as a reference model for use in a method for checking the quality of a crimp.

2. The method as claimed in claim 1, wherein, in a sixth step, further data characterizing the reference model and/or a crimp are stored, wherein the data comprise a time stamp and/or a location and/or ID information relating to the crimping device used and/or ID information relating to the operator and/or the predefined number and/or the predefined cable and/or the predefined contact sleeve and/or information relating to the assessment of force/displacement curves of faulty crimps.

3. The method as claimed in claim 1, wherein a performance of the method at least from the first step to the fourth step is added to a number of performances of the method which have already taken place, and/or, in the fifth step, the tolerance range is defined taking into account the number, and/or
the further data characterizing the reference model and/or a crimp comprise the number of performances.

4. A method for checking the quality of a crimp of a predefined cable with a predefined contact sleeve and with a predefined crimp height using a sensor system for measuring a force and a displacement of an apparatus for the actuation and/or pressure application of a crimping unit and an electronic evaluation system, wherein a force/displacement curve is detected during crimping and displayed on a screen, comprising the steps of:
a stored reference model is displayed on the screen together with the detected force/displacement curve, which reference model has a first and second envelope curve, which delimit a tolerance range;
a comparison of the force/displacement curve with the reference model is performed, wherein it is determined whether the force/displacement curve is in the tolerance range;
a statement relating to the quality of the crimp is generated from the comparison.

5. The method as claimed in claim 4, wherein the quality of the crimp corresponds to a predefined desirable quality if the force/displacement curve is in the tolerance range.

6. The method as claimed in claim 4, wherein the quality of the crimp is rejected if the force/displacement curve is at least partially outside the tolerance range.

7. The method as claimed in claim 6, wherein a qualitative fault analysis of the crimp is derived from the comparison of the force/displacement curve with the reference model.

8. The method as claimed in claim 1, wherein the force/displacement curves are used for updating the reference model, wherein step five and/or step six is performed, wherein the performance of a crimping process is added to the predefined number and/or the number of performances,
and wherein
the update is performed in an automated manner and/or at the instigation of an operator.

9. The method as claimed in claim 1, wherein the tolerance range is variable according to the displacement and/or the force.

10. The method as claimed in claim 1 wherein at least one Hall sensor is used for the displacement measurement and/or at least one piezoelectric sensor for the force measurement.

11. A crimping device for checking a quality of a crimp of a predefined cable with a predefined contact sleeve using a sensor system for measuring a force and a displacement of an apparatus for the actuation and/or pressure application of a crimping unit and an electronic evaluation system, wherein a force/displacement curve is detected during crimping and displayed on a screen, said device having the features:
the crimping unit is configured for press-connecting the cable to the contact sleeve;
the apparatus for the actuation of the crimping unit has a pneumatic pressure apparatus with a cylinder and a piston, which are in operative communication with the crimping unit via a lever; and
an adjustment mechanism is provided for setting a predefined crimp height;
wherein the crimping device is suitably designed for performing a method as claimed in claim 1.

12. The crimping device as claimed in claim 11, with at least one Hall sensor for the displacement measurement and/or at least one piezoelectric sensor for the force measurement.

13. The crimping device as claimed in claim 11, wherein the crimping unit is an indent crimping unit and preferably a two-mandrel crimping unit and particularly preferably a four-mandrel crimping unit, and wherein the contact sleeve is a turned contact sleeve.

14. The method as claimed in claim 4, wherein a first crimping device and a second identical crimping device are for checking the quality of the crimp, wherein each crimping device comprises a
crimping unit is configured for press-connecting the cable to the contact sleeve;
wherein the apparatus for the actuation of the crimping unit has a pneumatic pressure apparatus with a cylinder and a piston, which are in operative communication with the crimping unit via a lever; and
an adjustment mechanism is provided for setting a predefined crimp height;
wherein the crimping device is used for creating the reference model for checking the quality of a crimp of a predefined cable with a predefined contact sleeve and with a predefined crimp height using a sensor system for measuring a force and a displacement of an apparatus for the actuation and/or pressure application of a crimping unit and an electronic evaluation system, wherein a force/displacement curve is detected during crimping and displayed on a screen, said method comprising the steps of:
performing a crimp of a cable with a contact sleeve and detecting and displaying a force/displacement curve of the crimp on the screen in a first step;
assessing the quality of the crimp via visual inspection by an operator and/or with the use of suitable testing instruments in a second step;
using a force/displacement curve of a positively assessed crimp with a predefined quality for a family of force/displacement curves with a predefined number of force/displacement curves in a third step;
repeating the first, second and third steps with a further cable with a further contact sleeve, until a predefined number is reached, in a fourth step;
defining a tolerance range with a predefined tolerance and/or taking into account the predefined quality and/or the predefined crimp height and/or the predefined cable and/or the predefined contact sleeve and/or the predefined number by specifying a first and second envelope, which delimit the family of the force/displacement curves, in a fifth step;
recording the first and second envelope and/or the tolerance range and/or the family of force/displacement curves as a reference model for use in a method for checking the quality of a crimp, wherein a reference model is created using a second crimping device.

15. The method as claimed in claim 14, wherein the reference model is adapted to the characteristics of the first crimping device by updating the reference model wherein routines of a software program provided on the electronic evaluation system are used for performing the method and the method.
